(19) United States
(12) Patent Application Publication
(10) Pub. No.: US 2008/0229605 A1
(43) Pub. Date: Sep. 25, 2008

(54) GAS DRYING ASSEMBLY WITH CARTRIDGE AND METHOD

(76) Inventor: Jerome R. Brown, Barrington, IL (US)

Correspondence Address: WILDMAN HARROLD ALLEN & DIXON LLP, 225 WEST WACKER DRIVE, SUITE 2800, CHICAGO, IL, 60606, US

(21) Appl. No.: 11/690,557

(22) Filed: Mar. 23, 2007

(51) Int. Cl. F26B 21/06

(52) U.S. Cl. 34/73; 29/402.08

(57) ABSTRACT

An gas drying apparatus which comprises a housing comprising a sidewall defining at least one opening; ma gas drying material positioned within the housing; an inlet tube wherein at least a portion of the inlet tube is positioned inside the housing; and a piece of porous material positioned around the inlet tube and between the gas drying material and the opening. The invention includes a housing which comprises a sidewall which defines an opening wherein the housing contains a gas drying material, wherein an inlet tube is secured to the housing and at least a portion of the inlet tube is positioned within the housing; and a housing holder wherein the holder defines a cavity to receive the at least one opening.

### FIELD OF INVENTION

This invention relates to in-line gas dryers and more particularly to in-line gas dryers adapted to remove water vapor from a flow of compressed gas.

### BACKGROUND

There is a need to provide in-line gas dryers that provide ease, efficiency and convenience in replacing used or spent gas drying material employed by the gas dryer.

### SUMMARY OF THE INVENTION

The present invention relates generally to an improved in-line gas dryer.

The present invention includes a housing constructed of includes a sidewall which defines at least one opening; a gas drying material positioned within the housing; an inlet tube wherein at least a portion of the inlet tube is positioned inside the housing; and a piece of porous material positioned around the inlet tube and between the gas drying material and the opening.

The present invention includes a method for replacing used gas drying material, which includes the steps of removing a housing from a housing holder, wherein the housing includes a sidewall which defines at least one opening, wherein the housing contains at least a partially used gas drying material and wherein an inlet tube is secured to the housing and at least a portion of the inlet tube is positioned inside of the housing; and positioning another housing into the housing holder, wherein the other housing includes another sidewall which defines at least one opening; wherein the other housing contains a substantially unused gas drying material and wherein another inlet tube is secured to the other housing and at least a portion of the other inlet tube is positioned inside of the other housing.

The present invention also includes a gas drying assembly, which includes a housing which includes a sidewall that defines at least one opening in the housing, wherein the housing contains a gas drying material and wherein an inlet tube is secured to the housing and at least a portion of an inlet tube is positioned within the housing; and a housing holder wherein the holder defines a cavity to receive the at least one opening of the housing.

### BRIEF DESCRIPTION OF THE DRAWINGS

Certain embodiments of the present invention are illustrated by the accompanying figures. It should be understood that the figures are not necessarily to scale and that details that are not necessary for an understanding of the invention or that render other details difficult to perceive may be omitted. It should be understood, of course, that the invention is not necessarily limited to the particular embodiments illustrated herein.

FIG. 1 a front elevation view of a first embodiment the cartridge of the present invention;

FIG. 2 is a top plan view of the FIG. 1;

FIG. 3A is a cross sectional view of the first embodiment of the present invention as seen along line 3A-3A in FIG. 2;

FIG. 3B is a cross sectional view of a second embodiment of the present invention as seen along line 3B-3B in FIG. 2;

FIG. 3C is a cross sectional view of a third embodiment of the present invention as seen along line 3C-3C in FIG. 2;

FIG. 4 is a perspective view of the gas drying assembly of the present invention;

FIG. 5 is an exploded view of FIG. 4;

FIG. 6 is a plan view as seen along line 6-6 in FIG. 5;

FIG. 7 is a cross sectional view as seen along line 7-7 in FIG. 6 with showing the cartridge of the present invention in phantom and partial cutaway.

FIG. 8 is a plan view as seen along line 8-8 in FIG. 5; and

FIG. 9 is a cross sectional view as seen along line 9-9 in FIG. 8 with showing the cartridge of the present invention in phantom and partial cutaway.

### DETAILED DESCRIPTION

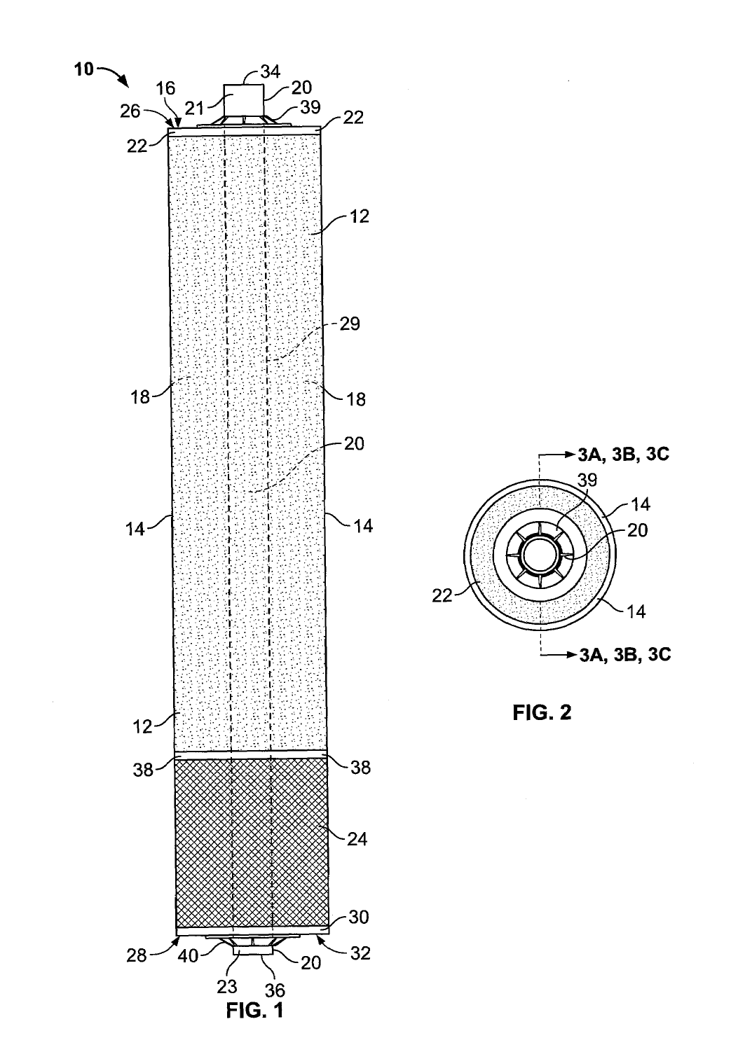

Referring to FIG. 1, an example of a gas drying apparatus of the present invention is cartridge 10 which is constructed of housing 12. Housing 12 is formed from sidewall 14 which defines at least one opening 16. Sidewall 14 can be constructed from a single integral piece or can be constructed from two or more pieces connected together. A gas drying material 18 is positioned inside of housing 12, as well as, at least a portion of inlet tube 20. A piece of porous material 22, as seen in FIGS. 1 and 2, is positioned proximate to opening 16. Porous material 22 is also positioned around inlet tube 20 and between gas drying material 18 and opening 16.

Cartridge 10 is employed to dry a compressed gas and typically this gas is air that is used to power pneumatic tools, paint spray guns and the like. The reduction of moisture content in the compressed air improves the performance and longevity of the equipment that it powers. A compressor will pressurize the gas or air and it will need to encounter air drying material to reduce the moisture content of the compressed gas prior to the gas reaching the equipment. Thus, cartridge 10 will be positioned typically on-line and between the compressor and the equipment to be powered.

Cartridge 10 will operate typically in a pressure range within of 25 to 175 pounds per square inch. The gas temperature it encounters is typically in a range from +35 degrees to +125 degrees Fahrenheit. However, it is contemplated that the operational pressure and temperature can each go outside of these typical ranges.

In operation of cartridge 10, gas drying material 18 will absorb moisture from the compressed gas that comes into contact with gas drying material 18 and as more moisture is absorbed the performance of the gas drying material 18 will be affected. To obtain optimal performance of cartridge 10, the gas drying material 18 will need to be replaced from time to time. In this invention, as will be discussed in more detail below, the entire cartridge 10 will be replaced by one that carries substantially unused gas drying material 18. Gas drying material 18 can be a number of items such as, e.g. desiccant.

As seen in FIG. 1, this embodiment of the invention has sidewall 14 of housing 12 constructed of a plastic material, such as ABS or MABS, which is suitable to operate in the temperature and pressure ranges discussed above. In this embodiment, the thickness of sidewall 14 is approximately 0.145 inches and will handle air pressures of approximately 175 pounds per square inch. In this example, housing 12 is constructed of a cylindrical shape wherein the length “l” is approximately 10 inches and an outside diameter of approximately 1.75 inches. The shape and dimensions of housing 12 will vary upon the needs of the user. The plastic material used in this embodiment is typically transparent or translucent, as desired. This particular design criterion permits a user to see into housing 12 and observe the condition of the gas drying material 18 as it progresses through its useful life.

In this example, the gas drying material is a desiccant known as silica gel such as sold by AGM Container Controls of Tucson, Ariz. Various sizes of the silica gel can be employed. In this example, it comes in the shape of a pellet and it ranges in size of 2 mm to 6 mm. Desiccant 18 used in this example also is capable of changing color. Prior to use the appearance in one example is orange in color, which indicates that it has been substantially unused. As desiccant 18 is used, the orange color changes to a green color in appearance which indicates desiccant 18 has been at least partially used. As the green color becomes more predominant, the gas drying material 18 becomes less effective and the desiccant will need to be replaced by replacing cartridge 10. This desiccant that changes color from orange to green is sold by AGM Container Controls known as Model #920013. Another example of this type of desiccant which changes color from blue to pink as it absorbs moisture, is sold also by AGM Container Controls as Model #920007.

Further referring to the embodiment shown in FIG. 1, charcoal particles 24 are also positioned in housing 12. Charcoal 24 in this embodiment is in a pellet form other forms of charcoal 24 can be used such as granular. Charcoal 24 positioned inside of housing 12, in this example, comes in pellet form wherein the size of the particles are approximately 3 mm to 4 mm. As discussed above, the gas drying material 18 absorbs moisture that is contained in the compressed air that passes over it. On the other hand, charcoal 24 absorbs impurities contained in the compressed gas such as oil vapor emitted by the compressor that is driving the gas or air. Thus, charcoal 24 will be positioned upstream from gas drying material 18 in order to remove the undesirable impurities such as oil vapor prior to them reaching gas drying material 18. If the oil vapor reaches gas drying material 18, it will prematurely reduce its effectiveness in drying the compressed air.

As seen in FIG. 1, housing 12 has opposing ends, end 26 and opposing end 28. Charcoal 24 is positioned closer to one end than the other and in this instance, charcoal 24 is positioned closer to end 28. As will be discussed below, end 28 is the end in which the compressed gas or air first engages in the interior of housing 12. Thus, the compressed gas will travel, in this embodiment, through charcoal 24 prior to reaching gas drying material 18.

Inlet tube 20 may be constructed of many types of materials suitable to carry the gas temperatures and pressures mentioned herein. In this embodiment inlet tube 20 is constructed of clear plastic such as MABS. Inlet tube 20 is constructed of a cylindrical shape is the embodiment, as seen in FIGS. 1-3C, although, inlet tube 20 can take on any desired shape. Inlet tube 20 extends along a length “l” of housing 12 and, in this example, is positioned and extends along an axis of symmetry “AS” of housing 12.

Inlet tube 20 carries the compressed gas which it has received from the compressor. This compressed air will contain the above-mentioned undesirable components such as moisture and oil vapor. Inlet tube 20 is instrumental in delivering this untreated compressed gas to cartridge 10.

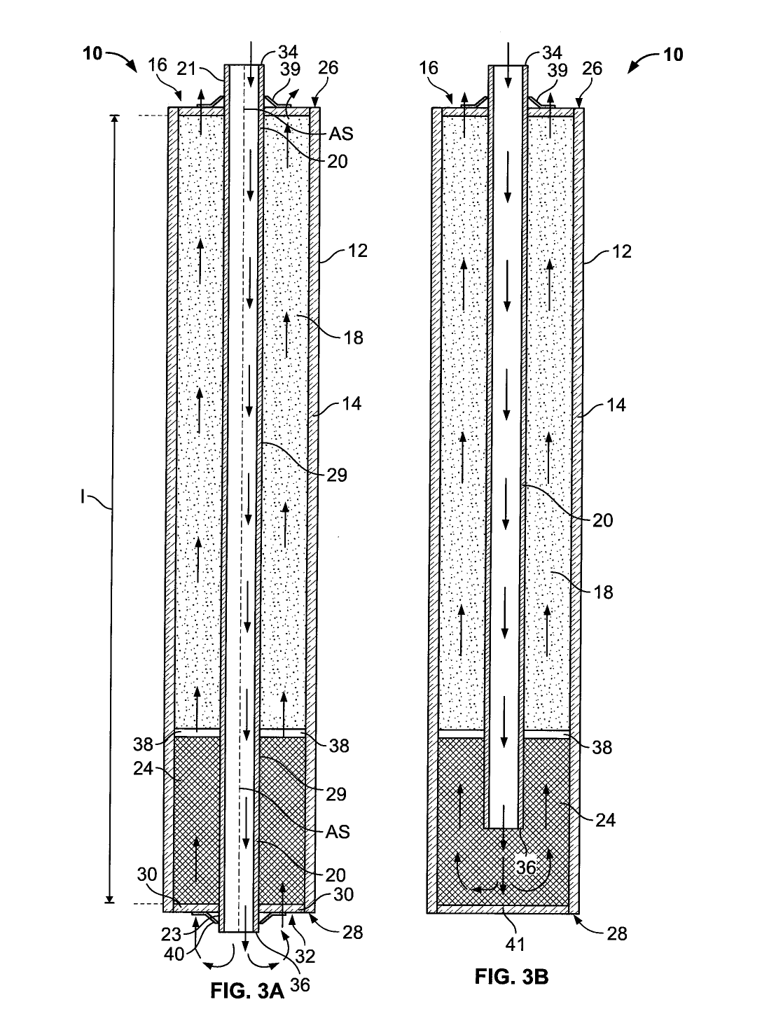

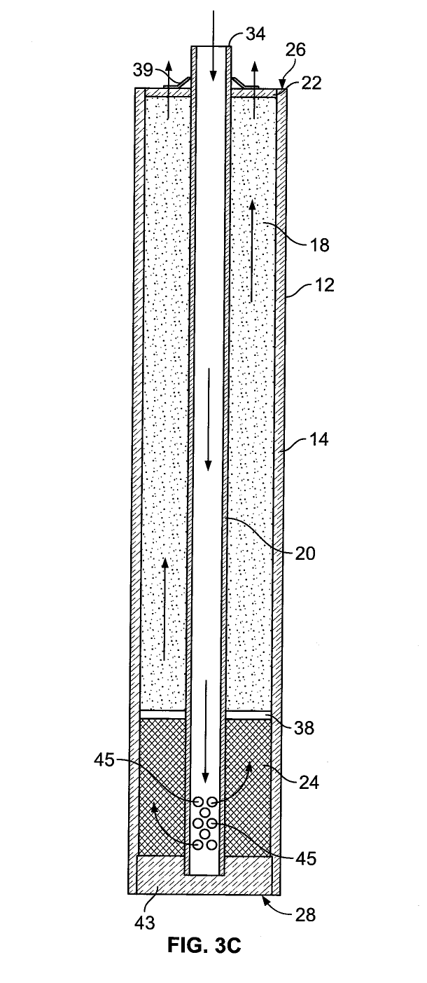

The compressed gas or air flow follows different paths depending on the embodiment of the invention that is being used. The first embodiment is shown in FIG. 3A. The compressed gas or air flow is illustrated by the arrows. In this embodiment, the compressed air or gas enters inlet tube 20 and passes through, in this embodiment, end 34 and through a portion 21 of inlet 20 positioned outside of housing 12. The compressed air is carried within inlet tube 20 and passes into, through and out of housing 12 without contacting any other contents, gas drying material 18 and charcoal 24, contained within housing 12. As seen in FIG. 3A, Gas drying material 18 and charcoal 24 are each positioned around an exterior surface 29 of inlet tube 20.

In the first embodiment, as seen in FIG. 3A, a further portion 23 of inlet tube 20 passes through second opening 32 which is defined by sidewall 14 of housing 12. Portion 23 and opposing end 36 of inlet tube are also positioned, in this embodiment, outside of housing 12. Once the compressed gas or air passes out of inlet tubing 20 at opposing end 36 of inlet tube 20, the arrows illustrate the air flow direction is back into housing 12 through another or second porous piece of material 30 positioned proximate to opposing end 28 of housing 12. This redirecting of the air flow back through other porous piece of material 30 and into housing 12 will be discussed in more detail below.

As mentioned earlier and seen in FIGS. 1 and 2, piece of porous material 22 is positioned around inlet tube 20 and between gas drying material 18 and opening 16. Similarly, other or second piece of porous material 30 is positioned around inlet tube 20 and positioned between, on the one side gas drying material 18 and charcoal 24 and on the other side, second opening 32. Both pieces of porous material 22 and 30 are spaced apart from one another with gas drying material 18 and charcoal positioned there between. Both pieces of porous material 22 and 30 can be constructed in a number of common ways. The structure in this embodiment is 90 micron sintered bronze. Alternatively a screen constructed of metal or other durable material or a perforated member or other common structure that permits compressed air to pass through it, yet provides an obstruction to materials contained in housing 12 and retain the materials in housing 12. Additionally, the structure provides obstruction to particles carried by the pressurized gas which will be ensnared or trapped and held thereby. Other porous piece of material 30 prevents particles entering housing 12 as the compressed air enters housing 12 through material 30 at opposing end 28. Preventing particles from entering housing 12 provides protection to the effectiveness of the gas drying material 18 and charcoal 24. Similarly, porous piece of material 22 positioned at end 26 operates to prevent particles from leaving housing 12 and traveling downstream to, for example, pneumatic tools that may be driven by the compressed gas.

Additionally, both pieces of porous material 22 and 30 are positioned approximate to ends 26 and 28 respectively. Each piece 22 and 30 are sized relative to their respective openings 16 and 32 such that an interference fit is created between sidewall 13 of housing 12 and porous pieces 22 and 30. The interference fit provides sufficient resistance to resist movement of pieces 22 and 30 during operation of cartridge 10 and thereby maintain desiccant 18 and charcoal 24 within housing 12. Other commonly known ways can be employed to secure porous pieces 22 and 30 in position relative to housing 12.

Once the compressed gas or air has passes through other or second piece of porous material 30, the compressed air encounters pieces of charcoal 24. As the compressed air passes through charcoal 24 the oil vapor and other impurities are removed from the compressed gas. The compressed gas then enters a region of the interior of housing 12 which contains the gas drying material 18. However, in this first embodiment, the compressed air first passes through barrier 38 positioned between charcoal 24 and gas drying material 18, before entering into gas drying material 18.

Barrier 38 is similar to the porous piece of material described above, barrier 38 allows the compressed gas to pass from charcoal 24 to gas drying material 18, however, barrier 38 prevents migration and intermingling of charcoal 24 and gas drying material 18. The migration and intermingling of these materials will reduce the effectiveness of cartridge 10. The structure employed for barrier 38 in this embodiment is a screen or perforated device constructed of metal or other durable material which has an opening size to allow the passage through of pressurized gas and small enough to prevent migration and intermingling of desiccant 18 and charcoal 24. Barrier 38 could also take on a structure of sintered bronze as described above for the pieces of porous material.

Once the compressed gas has passed through barrier 38, it enters into gas drying material 18. Gas drying material 18 then absorbs undesirable moisture from the compressed air or gas. The now drier compressed air or gas then passes out of housing 12 through piece of porous material 22, seen in FIGS. 3A. The drier gas is then directed to head down stream to operate pneumatic tools, paint spray guns or other pneumatic operated devices.

In this embodiment, gas drying material 18 and charcoal 24 are retained in housing 12, as discussed above, with the use of the interference fit of porous pieces 22 and 30 positioned on opposing ends of housing 12. Porous pieces 22 and 30 are appropriately sized to be coextensive with the inside of housing 12 so as to create the interference fit. Shaft retainers 39 and 40 are secured to inlet tube 20 at a position outside of porous pieces 22 and 30 respectively. Shaft retainers 39 and 40 provide additional support for porous pieces 22 and 30 so as to resist movement by pieces 22 and 30 away from housing 12 shaft retainers, as seen in FIGS. 1, 2 and 3A. In addition, shaft retainers 39 and 40 prevent inlet tube 20 moving relative to porous pieces 22 and 30. A number of different types of retaining devices may be used to secure to inlet tube 20 and thereby resist movement of porous material pieces 22 and 30 in a direction away from housing 12. In this embodiment, shaft retainers 39 and 40 secure to inlet tube 20 by cutting into the material which comprises inlet tube 20 and each of these retainers abut porous pieces of material 22 and 30, respectively. Retainers 39 and 40 each extend in a radial direction out from inlet tube 20. Thus, with porous pieces of material 22 and 30 each dimensioned to be coextensive to openings 16 and 26 respectively, charcoal 24 and gas drying material 18 are retained in housing 12.

Referring to FIG. 3B, this second embodiment of cartridge 10 is similarly structured as that of the embodiment shown in FIG. 3A. However, there are a few differences in the structures. In this second embodiment, a portion 41 of sidewall 14 of housing 12 closes opposing end 28 and thereby sidewall 14 does not define a second opening. Opposing end 36 of inlet tube 20 is positioned spaced apart from portion 41 of sidewall 14 and is immersed in particles of charcoal 24. In this embodiment, end 34 of inlet tube 20 is positioned closer to opening 16 than to portion 41 of sidewall 14 and opposing end 36 of inlet tube 20 is positioned closer to portion 41 of sidewall 14 which closes opposing end 28 of housing 12 than to opening 16. As discussed in the embodiment above, porous piece 22 is secured to sidewall 14 of housing 12 with an interference fit.

Thus, in observing the air flow path illustrated by the arrows in FIG. 3B, the compressed air passes out of opposing end 36 of inlet tube 20 directly into charcoal 24. Portion 41 of sidewall 14 which closes opposing end 28 redirects the compressed air upward through charcoal 24, through barrier 38 and into gas drying material 18. The dried compressed air then passes through piece of porous material 22 and is directed downstream, as will be discussed in more detail below, to power the pneumatic equipment.

Referring to a third embodiment 3C, inlet tube 20 is positioned spaced apart from portion 41 of sidewall 14, however end 36 of inlet tube 20 is closed by being inserted into a cavity formed in end wall 43. In this example, inlet tube 20 forms an interference fit with sidewalls of the cavity formed in end wall 43. In turn, end wall 43 also forms an interference fit with sidewall 14 of housing 12. Again, at the other end of housing 12, porous piece of material 22 forms an interference fit also with sidewall 14 of housing 12. In this embodiment, retainer clamp 39 and interference fit between inlet tube 20 and end wall 43 secures inlet tube 20 in position.

The pressurized air, as illustrated by the arrows, flow through inlet tube 20 and out of perforations 45 formed in inlet tube 20. To permit the incoming pressurized air to interact with charcoal 24 prior to reaching desiccant 18, perforations 45 are positioned so as to be surrounded by charcoal 24. Perforations 45 are preferably sized to be smaller than pieces of charcoal 24 which are positioned adjacent perforations 45.

The pressurized air, as illustrated by arrows, in this embodiment shown in 3C, passes through charcoal 24 and through barrier 38 and into air drying material 18. Once the pressurized air has passed through air drying material 18, the air passes through porous piece of material 22 and then down stream to the equipment to be operated by the pressurized air.

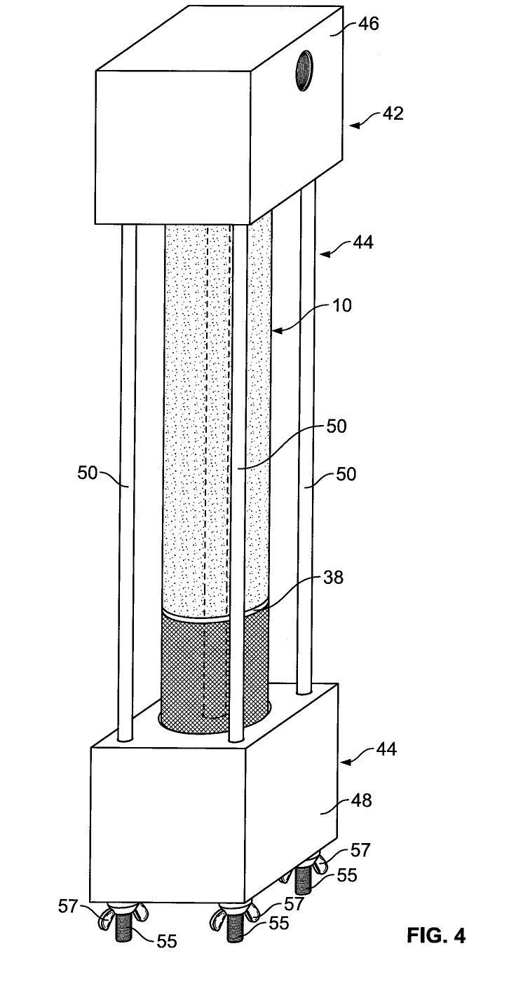

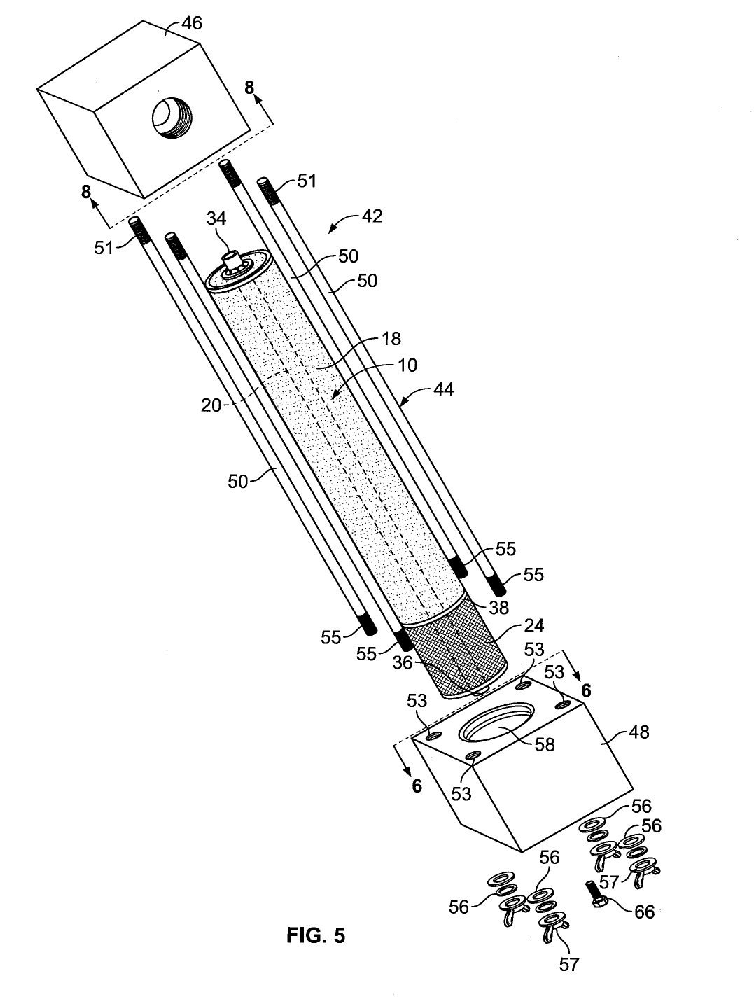

Referring now to the gas drying assembly 42 shown in FIGS. 4 and 5, we see cartridge 10 which has been described above, held by housing holder 44. Housing holder 44 can take on many different constructions. The example of holder 44 shown herein includes two opposing blocks 46 and 48 typically constructed of metal, nylon or plastic, wherein opposing blocks are secured together by tie rods 50.

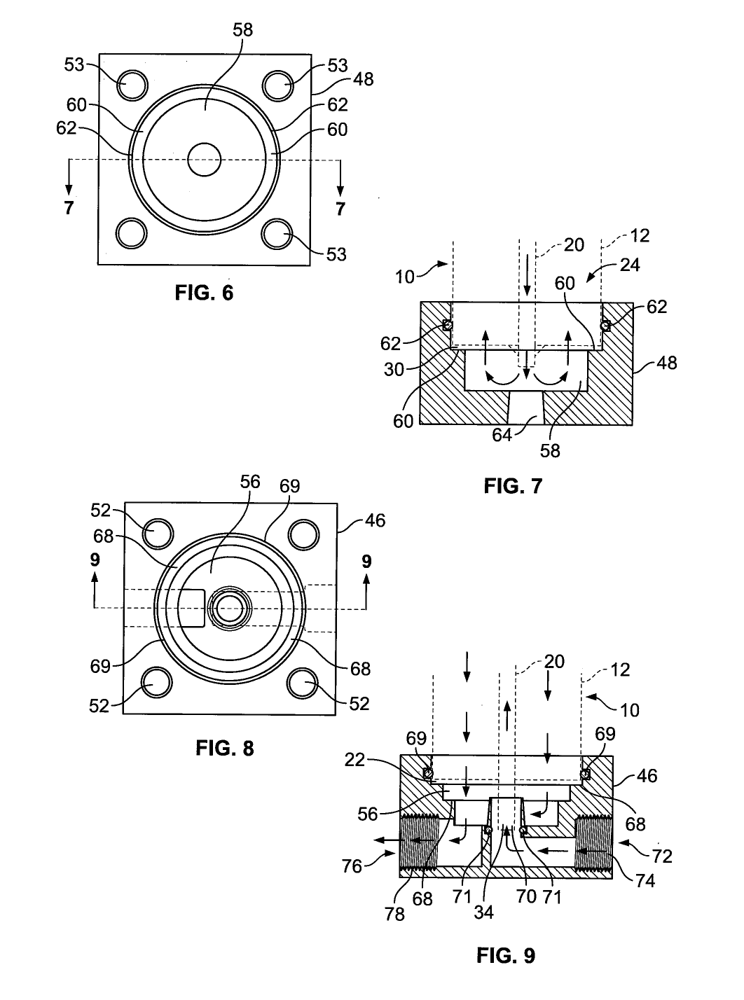

Tie rods 50 are threaded at each end. At one end 51 of each of tie rods 50 are screwed into threaded receptacles 52 of block 46, shown in FIGS. 5 and 8 and thereby secure tie rods 50 to block 46. Tie rods 50 extend through holes 53 positioned through block 48, as seen in FIGS. 4-6, such that the opposing threaded ends 55 project through the bottom of block 48 and washers 56 and nuts 57 can be tightened onto each of the threaded portions 55 which project through block 48 until blocks 46 and 48 secure cartridge 10 there between.

Prior to securing cartridge 10 between blocks 46 and 48, end 26 and opposing end 28 of housing 12 are positioned respectively within cavity 56 and second cavity 58 defined by blocks 46 and 48 respectively, see FIGS. 5-9. Second cavity 58 is dimensioned to receive housing 20 with second opening 32 snuggly. End 28 of housing 12 rests on ledge 60 defined in second cavity 58 as seen in FIG. 7. O-ring 62 provides a gas seal to prevent pressurized gas from escaping into the ambient atmosphere. As seen in FIG. 7, the first embodiment of cartridge 10, shown in phantom, is used. As shown by the arrows which illustrate the air flow path, the compressed air comes out of inlet tube 20 and flows into a bottom portion of second cavity 58. The compressed air is redirected to go upwardly through second piece of porous material 30 and into charcoal 24 positioned within housing 12. A threaded opening 64 is defined in block 48 wherein opening 64 provides access to otherwise closed cavity 58. Threaded opening 64 is closed during operation of the assembly through engagement of threaded bolt 66 with threaded opening 64, seen in FIG. 5.

Now referring to FIGS. 8 and 9, block 46 defines cavity 56 with a dimension that is compatible to provide a snug fit with housing 12. As seen in FIG. 9 cartridge 10 is shown in phantom, cavity 56 defines ledge 68 upon which end 26 of housing 12, will abut. O-ring 69 is positioned within cavity 56 to provide an air tight seal against pressurized air escaping cavity 56 along the outside surface of housing 12. End 34 of inlet tube 20 is received into passageway 70 and an air tight seal is created with o-ring 71 engaging the outside surface of inlet tube 20. Opening 72 communicates with inlet tube 20 providing inlet tube 20 the flow of pressurized air from the compressor, as illustrated by the arrows. Opening 72 provides a threaded 74 portion for securing a line hose to block 46. Another opening 76 is provided to receive the compressed gas or air from opening 16 wherein the air has passed through charcoal 24, gas drying material 18 and porous material 22 and out of housing 12 into cavity 56. Cavity 56 is in communication with other opening 76 and the treated pressurized air from cartridge 10 flows from cavity 56 into other opening 76. The arrows illustrate the compressed air passing from the desiccant 18, through porous piece of material 22 and into cavity 56 and other opening 76 away from housing 12. The treated air exits other opening 76 and moves down stream to operate the desired pneumatic equipment. Again, threaded portion 78 is provided in other opening 76 in order to secure a down stream hose to block 46.

Once the gas drying material 18 performance has been diminished, the housing holder 44 is disassembled and the old cartridge 10 is removed and a new cartridge 10 is positioned into and secured within housing holder 44. As can be appreciated, any of the embodiments of cartridge 10 described above can be utilized in housing holder 44. For example, if cartridge 10 which utilizes a closed end 28 of housing 12, end 28 is positioned into cavity 58 and no air passes into cavity 58 but housing 12 remains secured to block 48.

When the moisture absorption capacity of gas drying material 18 is at least partially used and its capacity to absorb moisture has been reduced, the need arises for replacing it with gas drying material 18 with higher absorbing capacity or substantially unused material. In this instance, the entire cartridge 10 containing the at least partially used gas drying material 18 and carrying inlet tube 20 is removed from housing holder 44 and disposed of. A new cartridge 10 containing substantially unused gas drying material 18 is positioned into and secured to housing holder 44 for continued use of the pneumatic equipment.

The foregoing description of examples and embodiments of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A gas drying apparatus, comprising:
a housing comprising a sidewall defining at least one opening;
a gas drying material positioned within the housing;
an inlet tube wherein at least a portion of the inlet tube is positioned inside the housing; and
a piece of porous material positioned around the inlet tube and between the gas drying material and the opening.

2. The gas drying apparatus of claim 1 wherein the housing is constructed of a plastic material.

3. The gas drying apparatus of claim 1 wherein the housing is constructed of a material that is translucent.

4. The gas drying apparatus of claim 1 wherein the housing is constructed of a material that is transparent.

5. The gas drying apparatus of claim 1 wherein the housing comprises a cylindrical shape.

6. The gas drying apparatus of claim 1 wherein the gas drying material is a desiccant.

7. The gas drying apparatus of claim 1 wherein the desiccant material comprises a plurality of pellets.

8. The gas drying apparatus of claim 7 wherein the desiccant material contains a material capable of changing color with absorption of moisture by the desiccant material.

9. The gas drying apparatus of claim 1 further includes particles of charcoal positioned within the container.

10. The gas drying apparatus of claim 9 wherein the housing comprises opposing ends wherein the particles of charcoal are positioned closer to one of the opposing ends of the housing.

11. The gas drying apparatus of claim 1 wherein the inlet tube is constructed of a plastic material.

12. The gas drying apparatus of claim 1 wherein the inlet tube is constructed of a cylindrical shape.

13. The gas drying apparatus of claim 1 wherein the housing is elongated and the inlet tube extends along a length of the housing.

14. The gas drying apparatus of claim 13 wherein the housing comprises an axis of symmetry and at least a portion of the inlet tube extends along the axis of symmetry.

15. The gas drying apparatus of claim 1 wherein the inlet tube comprises an end and an opposing end wherein the end is positioned inside of the housing spaced apart from an interior surface of the housing; wherein the inlet tube extends from the end of the inlet tube toward the opposing end of the inlet tube with the opposing end of the inlet tube positioned closer to the opening than the end of the inlet tube.

16. The gas drying apparatus of claim 15 wherein the inlet tube extends through the opening defined in the housing and the opposing end of the inlet tube is positioned outside of the housing.

17. The gas drying apparatus of claim 1 wherein the housing comprises an end and an opposing end wherein the opening is positioned at the end and wherein the sidewall of the housing defines a second opening positioned at the opposing end.

18. The gas drying apparatus of claim 17 wherein the inlet tube comprises an end and an opposing end, wherein the end of the inlet tube is positioned closer to the second opening than the opening and the opposing end of the inlet tube is positioned closer to the opening than to the second opening.

19. The gas drying apparatus of claim 17 wherein the end of the inlet tube is positioned outside of the housing and the opposing end of the inlet tube is positioned outside of the housing.

20. The gas drying apparatus of claim 18 including another piece of porous material wherein the other piece of porous material is positioned around the inlet tube and positioned between the gas drying material and the second opening.

21. The gas drying apparatus of claim 20 wherein the other piece of porous material is positioned between particles of charcoal positioned inside the housing and the second opening.

22. The gas drying apparatus of claim 21 wherein the other piece of porous material is constructed of sintered bronze.

23. The gas drying apparatus of claim 21 further including a clamp secured to the inlet tube to restrain the other piece of porous material from moving away from the second opening.

24. The gas drying apparatus of claim 1 wherein the piece of porous material is constructed of sintered bronze.

25. The gas drying apparatus of claim 1 including another clamp secured to the inlet tube to restrain the porous material from moving away from the opening.

26. The gas drying apparatus of claim 1 wherein at least a portion of the gas drying material is positioned around an exterior surface of the inlet tube.

27. A method for replacing used gas drying material, comprising the steps of:
removing a housing from a housing holder, wherein the housing comprises a wall which defines at least one opening; wherein the housing contains at least a partially used gas drying material; and wherein at least a portion of the inlet tube is positioned inside of the housing and secured to the housing such that the inlet tube is removed with the housing;
positioning another housing into the housing holder, wherein the other housing comprises another wall which defines at least one opening; wherein the other housing contains a substantially unused gas drying material; wherein another inlet tube is secured to the other housing and at least a portion of the other inlet tube is positioned inside of the other housing.

28. The method for replacing used gas drying material of claim 27 wherein the step of removing further includes a piece of porous material associated with the housing wherein the piece of porous material is positioned around the inlet tube and between the at least partially used gas drying material and the opening.

29. The method for replacing used gas drying material of claim 28 wherein the step of removing further includes a clamp secured to the inlet tube and extending away from the inlet tube blocking the piece of porous material from moving through the opening.

30. The method for replacing used gas drying material of claim 28 wherein the step of removing further includes the piece of porous material to be constructed of a dimension sufficient to be coextensive to the opening.

31. The method for replacing used gas drying material of claim 28 wherein the step of removing further includes the wall defining a second opening wherein the inlet tube passes through the opening and the second opening, a second piece of porous material is positioned around the inlet tube and spaced apart from the piece of porous material, wherein the at least partially used gas drying material is positioned between the piece and second piece of porous materials and wherein the second piece of porous material is positioned between the at least partially used gas drying material and the second opening.

32. The method for replacing used gas drying material of claim 27 wherein the step of removing further includes the housing containing pieces of charcoal.

33. The method for replacing used gas drying material of claim 27 wherein the step of positioning further includes a piece of porous material associated with the other housing wherein the piece of porous material is positioned around the other inlet tube and between the substantially unused used gas drying material and the opening.

34. The method for replacing used gas drying material of claim 33 wherein the step of positioning further includes another clamp secured to the inlet tube and extending away from the inlet tube preventing the piece of porous material from moving through the opening of the other housing.

35. The method for replacing used gas drying material of claim 33 wherein the step of positioning further includes the other wall defining a second opening in the other housing wherein the inlet tube passes through the opening and the second opening and another piece of porous material is positioned around the inlet tube and spaced apart the piece of porous material wherein the substantially unused gas drying material is positioned between the piece and the second piece of porous materials and wherein the second piece of porous material is positioned between the substantially unused gas drying material and the second opening.

36. The method for replacing used gas drying material of claim 35 wherein the step of positioning further includes the step of placing the second opening into a closed cavity defined in the housing holder.

37. The method for replacing used gas drying material of claim 35 wherein the step of positioning further includes the step of placing the opening into an open cavity defined in the housing holder.

38. The method for replacing used gas drying material of claim 27 wherein the step of positioning further includes the other housing containing pieces of charcoal.

39. A gas drying assembly, comprising:
a housing comprises a wall which defines at least one opening wherein the housing contains a gas drying material, wherein an inlet tube is secured to the housing and at least a portion of the inlet tube is positioned within the housing; and
a housing holder wherein the holder defines a cavity to receive therein a portion of the wall that defines the at least one opening.

40. The gas drying assembly of claim 39 wherein the housing is constructed of a transparent plastic.

41. The gas drying assembly of claim 39 wherein the housing is constructed of a cylindrical shape.

42. The gas drying assembly of claim 39 wherein the gas drying material is a desiccant.

43. The gas drying assembly of claim 42 wherein the desiccant is constructed into pellets.

44. The gas drying assembly of claim 42 wherein the desiccant changes color as it absorbs moisture.

45. The gas drying assembly of claim 39 further includes particles of charcoal contained within the housing.

46. The gas drying assembly of claim 39 wherein the inlet tube extends along a length of the housing.

47. The gas drying assembly of claim 39 wherein the inlet tube extends along an axis of symmetry of the housing.

48. The gas drying assembly of claim 39 wherein another portion of the inlet tube extends through the opening and is positioned outside of the housing.

49. The gas drying assembly of claim 48 wherein a piece of porous material is positioned around the inlet tube and between the gas drying material and the opening.

50. The gas drying assembly of claim 39 wherein the cavity defines an opening in communication with the inlet tube to receive gas.

51. The gas drying assembly of claim 39 wherein the cavity defines another opening in communication with the opening to carry gas away from the housing.

52. The gas drying assembly of claim 39 wherein the wall defines a second opening.

53. The gas drying assembly of claim 52 wherein the second opening is received by a second cavity defined by the housing holder.

54. The gas drying assembly of claim 52 wherein a further portion of the inlet tube extends through the second opening.

55. The gas drying assembly of claim 52 further includes a second piece of porous material positioned around the inlet tube and between the gas drying material and the second opening.

56. The gas drying assembly of claim 55 further includes a clamp secured to the inlet tube and extending away from the inlet tube.

57. The gas drying assembly of claim 55 wherein the second piece of porous material is of a dimension coextensive to a size of the second opening.

58. The gas drying assembly of claim 39 wherein an end of the housing opposing the opening is closed comprising a portion of the sidewall wherein an end of the inlet tube is positioned closer to the opening than to the opposing end of the housing and an opposing end of the at least portion of the inlet tube is positioned spaced apart from and closer to the portion of the sidewall than to the opening.

59. The gas drying assembly of claim 58 wherein the opposing end of the at least a portion of the inlet tube is immersed in particles of charcoal.
